(19) United States
(12) Patent Application Publication
(10) Pub. No.: US 2010/0109634 A1
(43) Pub. Date: May 6, 2010

(54) DESCRIPTION ELECTRO-AGEEB ELECTRICAL SAFETY DEVICE

(76) Inventor: Mahmoud Ajib, Tripoli (LY)

Correspondence Address: SALTER & MICHAELSON;THE HERITAGE BUILDING, 321 SOUTH MAIN STREET, PROVIDENCE, RI, 029037128, US

(21) Appl. No.: 12/377,158

(22) PCT Filed: May 12, 2006
(86) PCT No.: PCT/TR06/00019

§ 371 Date: Nov. 23, 2009

(51) Int. Cl. H01F 38/00

(52) U.S. Cl. 323/355

(57) ABSTRACT

ELECTRO-Ageeb Electrical Safety Device is a new invention that changes the dangerous electricity into a safe one. The new invention allows any human being, animal or any living body to touch live electrical terminals without feeling shock or exposed to any harm that usually happens in the ordinary electricity that is used everywhere nowadays. The invention is based on the principal of energy conversion. It converts the electric supplied by normal electric sources into a magnetic energy then indirectly converts the magnetic energy into a safe electric energy. The invented device can be installed in the main source of houses, public buildings, factories, schools, etc. to provide them with a safe current that protect people, machineries and all the building from any harm that could be happen from the normal electricity including fire. The new device has undergone through a series of experiments and tests and in all of them proves to be reliable in providing safety as well as assuring the continuity of electric supply.

The invention based on the principal of transformation of the electricity supplied from normal electric resources into magnetic energy; and then the transformation of the magnetic energy into safer electricity. Device, based on the invention, can be used in homes, public offices, factories and schools; and can supply safer flow that will protect human beings, buildings and machines from harmful effects of the normal electricity, including fire. Invention went through a series of tests and experiments and it is proved that the invention is safe and reliable on issues of safety and constant electric supply.

The idea behind designing ELECTRO-AGEEB device is based on the principle of energy transformations. Thus, the idea of the invention is transforming the electrical energy of the main source into static and safe electricity.

ELECTRO-AGEEB is neither borrowed nor plagiarized since it has never been proved, until the date of drawing up this report, that if a living being touches any pole of alternating current he/it will not be subjected to an electrical shock or its after-effects, as well as the risk of electric contact. This invention is considered as a scientific achievement that has a significant impact not only on the electrical industry, security systems, maintenance works and reduction of the electricity outage hours, but also on the modern way of life and the global economy. This device is put on the electrical energy inputs of the buildings and houses in order to transform this energy into safe electricity.

There is not any similar appliance similar to our invention in current systems that are used. In current devices, electrical shock is prevented by cutting the electricity of the system by turning off the switch of the device. To prevent electrical shock, currents systems cut off the electricity, however, with this new invention, the energy becomes safe within the device.

Some constants have been added to the general equation, namely:

Ageeb 1 constant (1.3×length×width×interval)

Ageeb 2 constant (45.0457321)

Ageeb 1 constant is calculated in accordance with:
The principle of calculation of the number of turns for one volt.
The principle of calculation of the rating of electromagnetic transformations.

### TECHNICAL DESCRIPTION OF ELECTRO-AGEEB DEVICE

ELECTRO-AGEEB Electrical-safety device is a kind of metal box, with geometric dimensions of (40×40×35 cm). These dimensions could change in accordance to the required capacity. From the case comes an electric cable connected to a socket for the power supply of the device from the usual source of energy (4) working on alternating current 110V-200-V400-H50 for this reason it is considered as an input to the appliance, and from the device comes three wires considered as its output (9) from which one can obtain various functioning potentials 12V-24V-110V-220V-440V as indicated on each one of them.

Inside the box, lies the core of the device concerned in accordance with the explicative diagrams attached, the functioning power of this device is 75 A, which is the average power for domestic consumption. This could be changed according to the application needed.

When transmitting the electrical power via high voltage cables (8) to the potential-reducing transformers (7), the measurement of voltage between one of the three poles, coming from the high-voltage-reducing transformer, and the earth pole gives us the volt reading of the current 50 H.Z., 220 V that is to say the earth has become a common point with the electrical network. Thus the intensity of current between the power cables and the earth plug is absolute zero, whereas the voltage varies between 10 to 35 volt. Here lies the role of the electrical-safety device ELECTRO-AGEEB; it receives the electric current supplied from the public electric current potential-reducing transformer (6, 7, 8) and transforming this current into a magnetic energy by means of energy absorption core (2) which is consists of metal slices (11) having Electro-physical properties separated by Fiberglass Electro-thermal insulating slices (12) The Cross-section of the fibreglass Electro-thermal insulating slices is 0.01 mm² and can bear heating up to 300° C. The magnetic energy is transformed into an electrical one by means of absorption coils (1) meant for the extraction of 110V, 220V or 440V current according to the needs. The electrical energy is indirectly transferred from the magnetic-energy-stimulating coil (5) by magnetic effect without any direct contact. Accordingly the current resulting from the absorption coil does not need to be connected to the earth anymore, i.e. the earthing has been totally eliminated.

The rating of the device is calculated as follows:

$$K . V . A = \frac{4.44 \times K \times L \times F \times A \times 1.73}{{10}^{8}} \times 1.3$$

Where

K=Number of flux lines.

L=number of turns in the primary and secondary coils

A=current intensity in the secondary coil in Amperes

F=Frequency of the source in Hz.

1.3=Ageeb 1 constant.

To calculate the capacity of the required transformer, we shall determine the rating and the capacity required from this device; after determining the rating transformed into watt we carry on as follows:

$$Number of turns per volt = \frac{45.0457321}{Core surface area ( cm 2 )}$$

$$45.0457321 = Ageeb 2 constant . \\ Number of total turns in the stimulation coil ( 5 ) = number of per volt \times 220$$

$$Number of turns in the absorption coil = number of turns for the core \times 220$$

$$Current intensity in the stimulation coil ( 5 ) = \frac{Flux}{Number of turns in the stimulation coil}$$

$$Current intensity in the absorption coil ( 11 ) = \\ A = \frac{Flux}{Number of turns in the absorption coil}$$

The area of the brass cable of the stimulation coil can be calculated as follows:

Area of the cable(mm2)=0.65×A

### Functions of ELECTRO-AGEEB Device

1) Although the device is supplied by electricity from an ordinary electrical source, the electrical energy issuing from it stands out from the normal electrical energy by the security of the person exposed to the risk of direct contact or electric shock, that is to say if someone touches one of the outside cables of the device (output)(9), he will not be subjected to any electric shock or its complications such as traumatism, burn or death as it happens when someone is subjected to normal electrical energy.
2) This device does not permit the flow of a superior electrical current to that for which it is manufactured; that means in the case of short-circuit or sudden increase of flow, it will only allow the flow of a given value of current that has been calculated at (75 ampere for this exposed model) without resulting in the disconnection of the device or subjecting the initial load to interference or break down or malfunction.
3) If the two poles come together to form short-circuit, we will notice a tiny spark compared to what would happen in normal circumstances, and if they touch the two cables at the same time, the maximum current that could be reached is at the rate of 75 amperes which is the rate allowed inside the appliance. In addition, it is possible, to any human being, to touch the contact point of the two cables that are connected to each other without feeling any blaze, hyperthermia or electric shock.

ABRAGEEB Automatic Relay (10):

The idea of the electric relay (1) has been formerly conceived in order to be used in motors that are called oil burners for low-capacity refrigerating devices to prevent the motor from restarting and to protect the regulation coils until obtaining a balance of the internal pressure between the condenser and the vaporizer inside the refrigeration circuit. But after the promotion of this idea and changing the materials manufactured from it, it has become possible to use it in transforming the energy and in short circuit circumstances where there is a high withstanding capacity and a strong sensitivity to any abnormal and unforeseen reaction since we put these circuits (4, 5, 6 and 7) at the beginning of the electrical energy outlet from the centre of transformation of the energy into a static electricity by putting them at the outlets of the current-conducting poles.

ABRAGEEB Current Relay (10) Functions:
a) It disconnects the electricity and reconnects it after the hazard has gone away.
b) The ABRAGEEB relay (10) cuts off the power automatically in case of a short circuit happen after the output of ELECTROAGEEB appliance.
c) Reduces the pressure, the intense loading and the severity of the consequences of short-circuits on the overall network; hence, a part from ELECTROAGEEB device is devoted to electrical safety.
d) The invention has several uses as far as the variety of possible voltages is concerned.
e) It is possible to design the device according to the need concerning the volume and the capacity.
f) Protection of the electrical appliances from failure when a sudden electrical contact occurs. In the case of a continuing contact, the device will automatically cut off the power few seconds after the contact in order to preserve the electrical circuits connected to the device. After few seconds from removing the contact, the electrical energy will come back.
g) There is no blast as in the cases of ordinary contact.

Technical Description of ABRAGEEB Relay (10):
a) The outer framework (13) is made of fibreglass or marble or from two welded tins.
b) Thermal chrome resistance (15) adapted to the design
c) Metal ring (14) with constant diameter as required by the design and having particular electro-physical properties as illustrated in the figure.
d) Electro-thermal changing foils (17) having different physical properties from those of the ring.
e) Two brass connection poles (15) with intermittent contact.
f) The circular cover of thermal obstruction inside the ABRAGEEB relay (10) is made of fibreglass having particular electro-thermal properties.

Table of Tests

A number of tests have been carried out to take the measurements at the loading as illustrated in

| | | | | Current |
|---|---|---|---|---|
| | | | | passing |
| | | Output | Loading | through |
| Number | Load | Voltage V | voltage V | load A |
| 1 | Flashlight | 220 | 196 | 3.74 |
| | | 400 | 323 | 5.04 |
| 2 | Heating | 200 | 186.5 | 6.8 |
| | load (electric | | | |
| | heating) | | | |
| 3 | Flashlight + | 400 | 305 | 6.04 |
| | motor (drill) | | | |

It is worthy noticing that the voltage obtained in the absence of load is 210 or 425 V.

### DRAWINGS

FIG. 1—The general plan of ELECTRO-AGEEB ELECTRICAL SAFETY DEVICE invention

FIG. 2—Electro-thermal insulating slices

FIG. 3—General Plan of ABRAGEEB relay

FIG. 4—Longitudinal section of the ABRAGEEB relay

FIG. 5—Internal section of the AGREEB relay

FIG. 6—Internal section of the electro-thermal foil of the ABRAGEEB relay

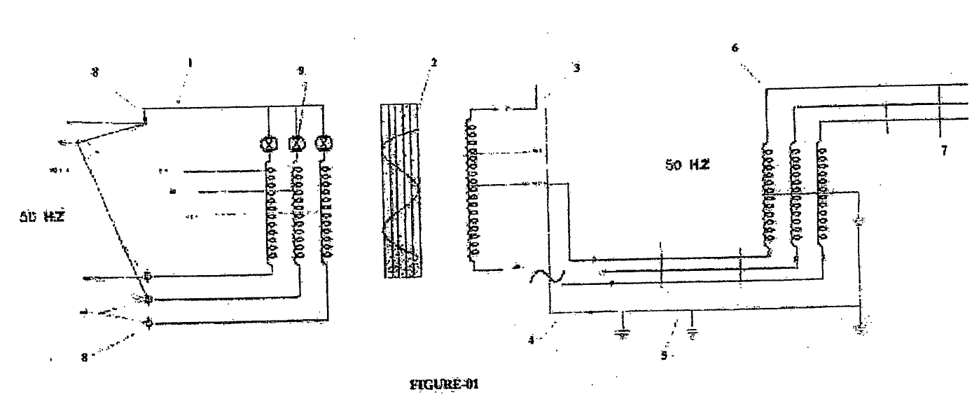

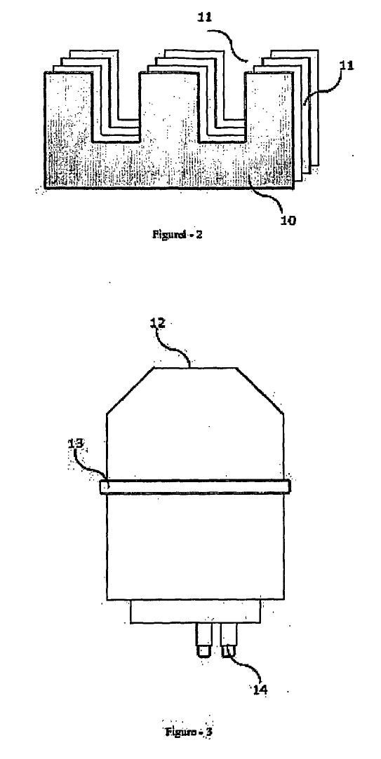

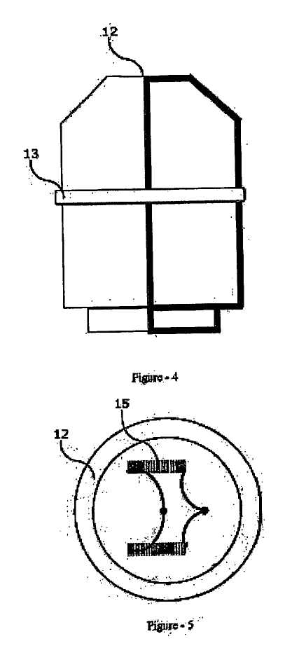

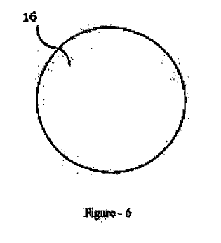

The Nominations of the invention's parts;
1. Absorbtion coil,
2. Absorption core
3. Electric cable connected to a socket for the power supply of the device from the usual source of energy Uyan kabini
4. Magnetic-energy-stimulating coil Ytilcsek voltaj kablolan
5. Low voltage cable
6. High Voltage Cable
7. Transformation of high voltage to low voltage
8. Output
9. ABRAGEEB Automatic relay
10. Metal slices
11. Fiberglass Electro-thermal insulating slices
12. Outer framework
13. Metal ring
14. Brass connection poles
15. Chrome Resistance
16. Electro-thermal changing foils

1. The invention relates to an electrical safety device converts the ordinary electricity to a magnetic energy and then indirectly to a safe and static electric energy. The safe electricity stands out from the normal electricity by the security of the person exposed it from the electric shock or its complications such as traumatism, burn or death as it happens when someone is subjected to normal electrical energy. A tiny spark would be notice incase of short circuit. The invention comprises an input supplying the device by ordinary electricity from the ordinary electric sources, stimulation coil and energy absorption cone, having the metal slices separated by fiber glass insulating slices attached to it, converts the electric energy to a magnetic energy and the absorption coil which converts the resulting magnetic energy into 110V, 220V or 440V electrical energy based on the current needed. The magnetic energy is converted to an electric one by magnetic effect only without any direct contact between the stimulation and absorption coils and the earthing is totally eliminated. Abrageeb automatic relay which is connected just before the output of the devices to protect it from any unforeseen or abnormal reaction where it cuts the electricity in case of short circuit and connects it automatically once the danger has gone away. It comprises an outer frame made of marble or fiberglass, thermal chrome resistance, metal ring having constant diameter, electro-thermal changing foils having physical properties differs from those of the metal ring, circular cover of the thermal obstruction having special electro-thermal properties and two brass connection poles with intermittent contact.

2. The electric safety device according to claim-1 characterized in that it is an electric safety device that enables the normal electricity to be converted to a magnetic energy and then indirectly to a static and safe electric energy.

3. The electric safety device according to claim-1 characterized in that a tiny spark will be notice if the two poles comes out of the device connected together compared to what happens in normal electricity.

4. The electric safety device according to claim-1 characterized in that the device is connected to the ordinary electric sources.

5. The electric safety device according to claim-1 characterized in that it is possible to obtain various functioning potentials 12V-24V-110V-220V-440V coming out of the device as needed.

6. The electric safety device according to claim-1 characterized in that the allowable current value of the device is 75 A, and it is possible to be changed based on the application needed.

7. The electric safety device according to claim-1 characterized in that the electrical current transmitted from the transformer is converted to a magnetic energy by means of a core where metal slices with special electro-physical properties are attached.

8. The electric safety device according to claim-1 characterized in that the magnetic energy is converted into electric energy indirectly by means of magnetic effect without any direct contact between the simulation coils and the absorption coils.

9. The electric safety device according to claim-1 characterized in that the current coming out of the device does not need to be connected to the earth any more where the earthing is totally eliminated.

10. The electric safety device according to claim-1 characterized in that the Abrageeb relay cuts the electricity and reconnects it when the danger is removed.

11. The electric safety device according to claim-1 characterized in that all the electrical devices using the electricity outputted from the device will be protected, without being affected, from the current variations in case of sudden electric contacts and interrupts.

12. The electric safety device according to claim-1 characterized in that thermal insulators and reflectors are used in the metal slices.

13. The electric safety device according to claim-1 characterized in that in the calculation of the rating and the number of turns per volt two constants has been used namely: Ageeb constant 1 and Ageeb constant 2.

14. The electric safety device according to claim-1 characterized in that the number of electrical energy transmission lines has been decreased when using the electricity coming out of the device.
